(19) United States
(12) Patent Application Publication
(10) Pub. No.: US 2015/0377688 A1
(43) Pub. Date: Dec. 31, 2015

(54) SENSOR AND METHOD OF MANUFACTURING SENSOR

(71) Applicant: Yazaki Corporation, Tokyo (JP)

(72) Inventors: Toshiaki FUKUHARA, Shimada-shi (JP); Ryo HIROSE, Shimada-shi (JP); Shinpei KATO, Shimada-shi (JP)

(73) Assignee: YAZAKI CORPORATION, Tokyo (JP)

(21) Appl. No.: 14/849,099

(22) Filed: Sep. 9, 2015

Related U.S. Application Data
(63) Continuation of application No. PCT/JP2014/056120, filed on Mar. 10, 2014.

(30) Foreign Application Priority Data
Mar. 14, 2013 (JP) 2013-051939

(51) Int. Cl. G01F 23/76; G01F 23/38

(52) U.S. Cl. CPC G01F 23/76; G01F 23/38

(57) ABSTRACT

A sensor includes: a Hall IC that outputs an electrical signal depending on a liquid level which is a detection object; a condenser used together with the Hall IC; a plurality of lead frames that includes a terminal portion to which a lead wire is connected, and a base portion to which a lead of the Hall IC is connected; and an inner member that holds the plurality of lead frames. In the inner member holding the lead frame, a space portion recessed in a concave shape is formed, and the Hall IC is accommodated in the space portion. Further, a condenser is mounted between a pair of the leads present in the space portion.

### CROSS-REFERENCE TO RELATED APPLICATION

This application is a continuation application of International Application PCT/JP2014/056120, filed on Mar. 10, 2014, and designating the U.S., the entire contents of which are incorporated herein by reference.

### BACKGROUND OF THE INVENTION

1. Field of the Invention

The present invention relates to a sensor and a method of manufacturing the same.

2. Description of the Related Art

Conventionally, various sensors that detect a physical quantity relating to a detection object, or the amount of a variation in the detection object have been known, and examples of the detection object include temperature, pressure, a flow rate or the like. As one of these sensors, there is a liquid level sensor of which a detection object is a liquid level. The liquid level sensor performs detection of the liquid level depending on behavior of a float vertically moving according to a variation in the liquid level. For example, the behavior of the float is transmitted to an arm, and an annular magnet, mounted to a sensor housing in a rotatable manner, is rotated by rotation of the arm. Further, a variation in a magnetic flux density occurring around the magnet is detected by a detection circuit provided inside the sensor housing, thereby detecting the liquid level.

For example, Japanese Patent Application Laid-Open No. 2008-14917 discloses a liquid level detecting device that detects a liquid level inside a tank. The liquid level detecting device is provided with a main body portion as a housing, and the main body portion is provided with a Hall integrated circuit (Hall IC) which is a detection element that detects a rotation angle of a ration portion rotating depending on behavior of a float, and a terminal configured to electrically connect the Hall IC to outside. The Hall IC includes a Hall element, a preamplifier, or the like therein. When a magnetic field is applied from the outside in a state in which a voltage is applied to the Hall element, the Hall element generates a Hall voltage proportional to a magnetic flux density of the magnetic field passing therethrough. The Hall voltage is amplified by the preamplifier and transmitted to an external circuit which is a higher-level device. The terminal is formed of a conductive metal plate, and provided with a signal terminal for a measurement signal of the Hall IC, a ground terminal for ground of the Hall IC, and a power supply terminal for power supply of the Hall IC. The signal terminal is connected to a signal lead of the Hall IC, the ground terminal is connected to a ground lead of the Hall IC, and the power supply terminal is connected to a power supply lead of the Hall IC.

In the liquid level detecting device, there is a concern that the preamplifier or the like of the Hall IC is electrically damaged when a high voltage pulse such as static electricity is applied to the signal terminal or the power supply terminal. Therefore, a first chip condenser and a second chip condenser that electrically protect the Hall IC are fixed to a mounting seat by soldering, and electrically connected to the terminal. To be specific, one end of one of the chip condensers is electrically connected to the ground terminal, and the other end thereof is electrically connected to the signal terminal. In addition, one end of the other chip condenser is electrically connected to the ground terminal, and the other end thereof is electrically connected to the power supply terminal. In this manner, even in a case where the high voltage pulse is input, the pulse flows out to the ground terminal via the chip condenser, and thus, is not applied to the preamplifier or the like of the Hall IC. As a result, it is possible to prevent the preamplifier or the like of the Hall IC from being electrically damaged.

Meanwhile, according to the technique disclosed in Japanese Patent Application Laid-Open No. 2008-14917, the condenser and a detection element are arranged at separated positions so that there is a possibility that an effect of noise elimination deteriorates. In addition, since the condenser and the detection element are arranged to be separated from each other, downsize of a structure has been hindered.

### SUMMARY OF THE INVENTION

The present invention has been made in view of such a situation, and an object thereof is to provide a sensor that is excellent in downsize of a structure and an effect of noise elimination and a method of manufacturing the same.

In order to achieve the above mentioned object, a sensor according to one aspect of the present invention includes a detection element configured to output an electrical signal depending on a physical quantity relating to a detection object or an amount of a variation in the detection object; an electronic component configured to be used together with the detection element; a plurality of lead frames configured to include a terminal portion to which a conductive wire is connected, and a base portion to which a lead of the detection element is connected; and an inner member configured to hold the plurality of lead frames, wherein the inner member includes a space portion recessed in a concave shape, and accommodates the detection element in the space portion, and the detection element extends a plurality of the leads included in the detection element itself from the space portion so as to be connected, respectively, to the base portion of the plurality of lead frames, and mounts the electronic component between a pair of the leads present in the space portion.

Herein, in the sensor according to another aspect of the present invention, it is preferable that the space portion is molded by a resin material filled in a space.

Further, in the sensor according to still another aspect of the present invention, it is preferable to further include a sensor housing configured to be obtained by insert-molding the plurality of lead frames and the inner member, as insert components, so as to expose a terminal portion of each of the lead frames and accommodate remaining portions of each of the lead frames.

Similarly, in order to achieve the above mentioned object, a method of manufacturing a sensor, according to still another aspect of the present invention, that accommodates a detection element, which outputs an electrical signal depending on a physical quantity relating to a detection object or an amount of a variation in the detection object, inside a sensor housing, the method includes a step of preparing a plurality of lead frames including a terminal portion of which a distal end is connected with a conductive wire; a step of insert-molding the plurality of lead frames as an insert component, and forming an inner member that holds a base end side of the plurality of lead frames and includes a space portion recessed in a concave shape; a step of accommodating the detection element in the space portion of the inner member, and extending a plurality of leads included in the detection element from the space portion so as to be connected, respectively, to the plurality of lead frames; a step of mounting an electronic component, which is used together with the detection element, between a pair of the leads present in the space portion; a step of filling the space portion with a resin material, and molding an inside of a space of the space portion; and a step of forming the sensor housing so as to expose the terminal portion of each of the lead frames and accommodate remaining portions of each of the lead frames.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view schematically illustrating a liquid level sensor according to the present embodiment;

FIG. 2 is an explanatory view of a lead frame assembly;

FIG. 3 is a perspective view illustrating an enlarged space portion formed in an inner member;

FIG. 4 is an explanatory view illustrating a manufacturing process of the liquid level sensor;

FIG. 5 is an explanatory view illustrating the manufacturing process of the liquid level sensor; and

FIG. 6 is an explanatory view illustrating the manufacturing process of the liquid level sensor.

### DETAILED DESCRIPTION OF THE PREFERRED EMBODIMENTS

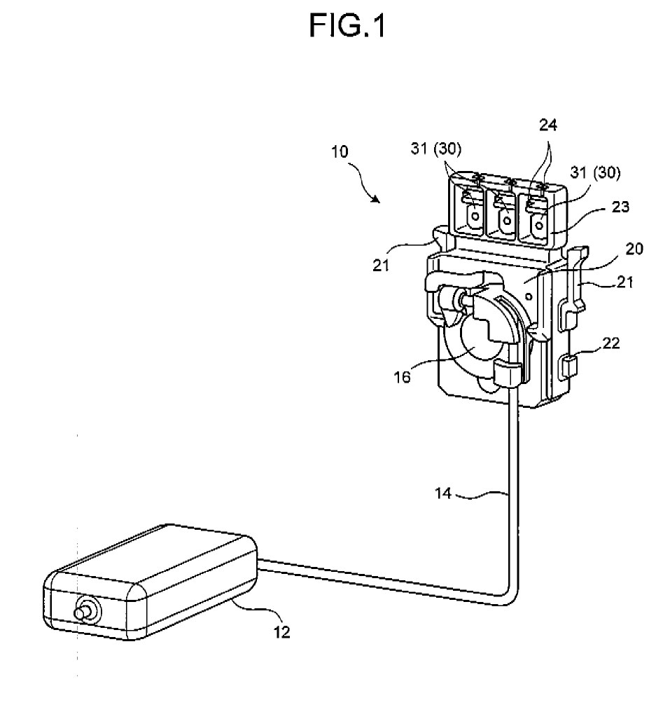

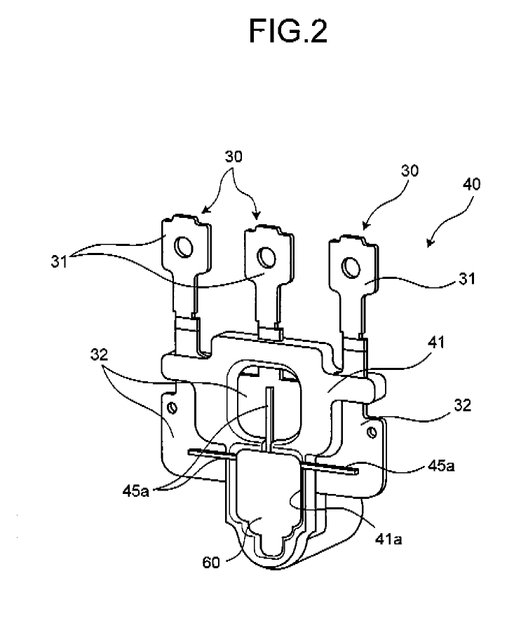

FIG. 1 is a perspective view schematically illustrating a liquid level sensor 10 according to the present embodiment, and FIG. 2 is an explanatory view of a lead frame assembly 40. The liquid level sensor 10 is a sensor of which a detection object is a liquid level of fuel that is stored in a fuel tank of an automobile, and is provided with a float 12, an arm 14, a holder 16 and a sensor housing 20.

The float 12 vertically moves in accordance with fluctuation in a liquid level inside the fuel tank. One end of the arm 14 is connected to the float 12, and the other end thereof is connected to the holder 16. The holder 16 is attached to a predetermined position of the sensor housing 20 in a rotatable manner, and a ring-shaped magnet (not illustrated) is provided to an inner side of the holder 16.

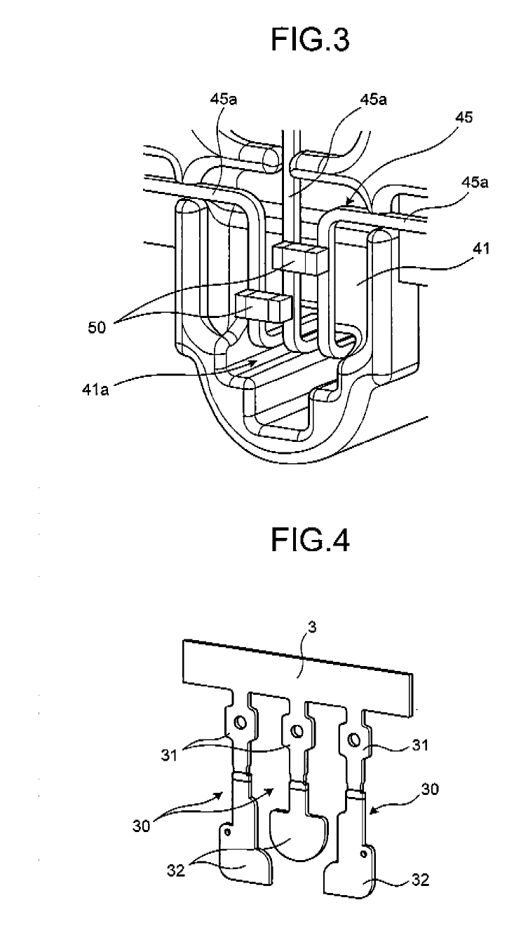

The sensor housing 20 is obtained by insert-molding the lead frame assembly 40, which is combined with a lead frame 30, a Hall IC 45 (see FIG. 3), or the like to be described later, as an insert component. In a state of exposing only a terminal portion 31 of the lead frame 30 to outside, the sensor housing 20 accommodates the remaining portions of the lead frame 30 therein, in the present embodiment. It is possible to use a polyacetal resin, a PPS resin or the like as the sensor housing 20.

The sensor housing 20 has piece portions 21, and hook portions 22 that extend in a vertical direction and can be elastically deformed, respectively, at right and left side surface portions thereof. Here, the fuel tank has a pump (not illustrated) sending the fuel to the outside, and the liquid level sensor 10 is attached to, for example, a pump holder of the pump. The piece portion 21 and the hook portion 22 can fix the liquid level sensor 10 to the pump holder without rattling by being engaged with an engagement member at the pump holder side.

In addition, in the sensor housing 20, a peripheral wall portion 23, formed to surround a periphery of the terminal portion 31, is formed at an upper edge portion to which the terminal portion 31 of the lead frame 30 to be described later exposes. In this manner, it is possible to suppress a leakage current generated between the terminal portions 31 by covering the periphery of the terminal portion 31 using the peripheral wall portion 23.

In addition, a lead wire insertion portion 24 is formed in the peripheral wall portion 23 by notching the peripheral wall portion 23 in a depth direction of the sensor housing 20. The lead wire insertion portion 24 is configured to fix and hold a lead wire (a conductive wire) to be connected to the terminal portion 31.

As illustrated in FIG. 2, the lead frame assembly 40 is configured with the lead frame 30, an inner member 41, the Hall IC 45 and a condenser 50.

The lead frame 30 is a circuit member, made of a metal plate, configured to electrically connect the Hall IC 45 to an external circuit, and can be formed using, for example, a metal plate obtained by performing tin plating on brass, stainless steel, iron, or the like. The lead frame 30 is prepared corresponding to the number of leads 45a included in the Hall IC 45, and in the present embodiment, three lead frames 30 are prepared. Each of the lead frames 30 is configured by using one plate-shaped member, and configured with the terminal portion 31 at a distal end side thereof, and a base portion 32 at a base end side thereof. A through-hole through which the lead wire is inserted is formed at a central portion of the terminal portion 31.

The inner member 41 includes and holds the base portion 32 which is the base end side of the lead frame 30. In addition, a space portion 41a, recessed in a concave shape toward the depth direction, that is, a thickness direction of the sensor housing 20, is formed in the inner member 41. The space portion 41a is molded by a resin material 60 filled in a space thereof. In other words, the space portion 41a is filled with the resin material 60.

FIG. 3 is a perspective view illustrating the enlarged space portion 41a formed in the inner member 41. Incidentally, in FIG. 3, a description regarding the resin material 60 filled in the space portion 41a is omitted. The Hall IC 45, which is a detection element, is configured by using a Hall element, an amplification circuit or the like, and is accommodated inside the space portion 41a of the inner member 41. In addition, the Hall IC 45 is provided with three leads 45a corresponding to a signal, ground and power supply. These leads 45a extend in parallel inside the space portion 41a, then extend to outside from the space portion 41a, and are connected to the corresponding lead frames 30 (the base portion 32), respectively.

The Hall IC 45 magnetically detects a rotation position of the arm 14, and outputs an electrical signal depending on the rotation position as a liquid level signal. To be specific, in a case where a liquid level inside a fuel tank varies, a vertical position of the float 12 fluctuates so that the holder 16 and the magnet provided in the holder 16 are rotated through the arm 14. At this time, a magnetic flux density of a magnetic field passing through the Hall element varies, and thus, an output voltage output by the Hall IC 45 (the Hall element) varies. Thus, it is possible to detect the rotation position of the arm 14, that is, the liquid level by detecting the liquid level signal which is the output voltage of the Hall IC 45.

The condenser 50 is an electronic component used together with the Hall IC 45, and is a chip condenser in which electrodes are formed at both ends thereof in the present embodiment. The condenser 50 is configured to electrically protect the Hall IC 45 from a high voltage such as static electricity, and is directly mounted to the lead 45a of the Hall IC 45. To be specific, the condenser 50 is mounted between a pair of the leads 45a, which correspond to the ground and signal, and further, is mounted between a pair of the leads 45a which correspond to the ground and power supply. Each of the condensers 50 is provided to be positioned inside a range of the space portion 41a.

As described above, the space portion 41a of the inner member 41 is molded by the resin material 60 filled in the space as illustrated in FIG. 2. In this manner, the Hall IC 45 and a pair of the condensers 50 are formed in a molded state using the resin material 60.

Hereinafter, a description will be made regarding a method of manufacturing the liquid level sensor 10 according to the present embodiment with reference to FIGS. 4 to 6. FIGS. 4 to 6 are explanatory views illustrating manufacturing processes of the liquid level sensor.

As illustrated in FIG. 4, in a first step, a punching process is performed to a sheet metal, which is a base material, and the three lead frames 30 are produced. The respective lead frames 30 are formed along a required shape, such as the terminal portion 31 and the base portion 32, and are connected in an integrated manner by a strip-shaped connection portion 3.

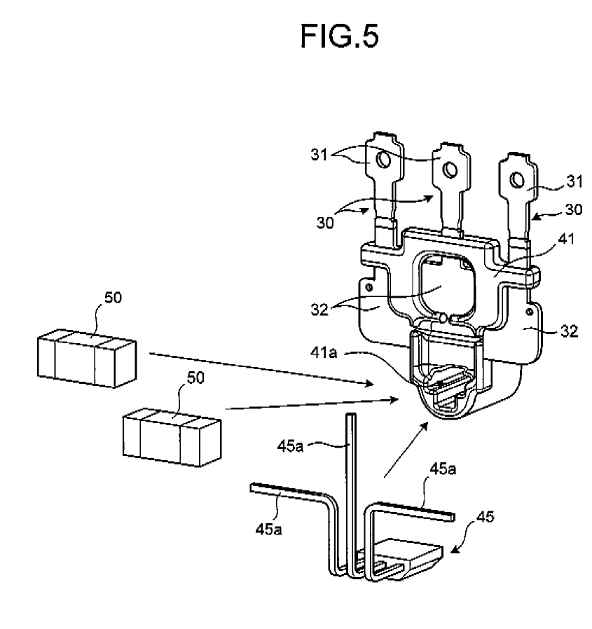

As illustrated in FIG. 5, in a second step, these lead frames 30 are insert-molded, as insert components, to form the inner member 41. The inner member 41 is provided with the space portion 41a to be formed in a concave shape according to a predetermined shape of a mold, and further, is formed so as to hold the base portion 32 side of the three lead frames 30. In addition, the above-described strip-shaped connection portion 3 is cut and removed at a required timing.

In a third step, the Hall IC 45 is accommodated in the space portion 41a of the inner member 41. The three leads 45a provided in the Hall IC 45 extend from the space portion 41a, and are connected, respectively, to the base portions 32 of the three lead frames 30. each of the leads 45a is processed into a predetermined bent shape in advance on consideration of the connection with the lead frame 30. In addition, it is possible to use, for example, welding for the connection between the lead 45a and the lead frame 30.

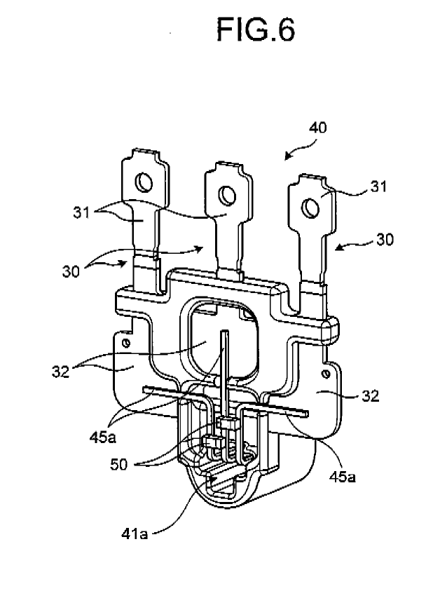

In a fourth step, the condenser 50 is mounted to the lead 45a of the Hall IC 45. To be specific, the three leads 45a extend in parallel to one another inside the space portion 41a such that the lead 45a corresponding to the ground is arranged at the center, and the leads 45a corresponding to the power supply and the signal are arranged at both sides thereof. In this manner, as illustrated in FIG. 6, the condensers 50 are mounted, respectively, between each pair of the leads 45a neighboring one another. It is possible to use, for example, soldering as a method of mounting the condenser 50.

As illustrated in FIG. 2, in a fifth step, the space portion 41a is filled with the resin material 60 so as to mold the inside of the space of the space portion 41a. In other words, in the fifth step, the inside of the space of the space portion 41a is filled with the resin material 60. According to the processes that have been performed until this fifth step, the lead frame assembly 40 combined with the lead frame 30, the Hall IC 45 or the like is produced.

In a sixth step, the lead frame assembly 40 is insert-molded, as an insert component, to form the sensor housing 20. As illustrated in FIG. 1, the sensor housing 20 is formed such that only the terminal portion 31 of the lead frame 30 is exposed to the outside, and the remaining portions of the lead frame assembly 40 are accommodated in the sensor housing 20. In addition, the sensor housing 20 is formed to surround the terminal portion 31 exposed to the outside by the peripheral wall portion 23.

In a seventh step, one end of the arm 14 is connected to the float 12, and the holder 16 is fitted into the other end thereof. Further, the ring-shaped magnet is provided at the inner side of the holder 16 to attach the holder 16 to a predetermined position of the sensor housing 20. At this time, a member such as a bearing is provided at the inner side of the holder 16, and the holder 16 is formed to be a rotatable state with respect to the sensor housing 20.

Through such a series of processes, the liquid level sensor 10 according to the present embodiment as illustrated in FIGS. 1 to 3 is manufactured.

In the present embodiment, the inner member 41 holding the lead frame 30 is formed with the space portion 41a recessed in the concave shape, and the Hall IC 45 is accommodated in the space portion 41a. Further, the Hall IC 45 extends a plurality of the leads 45a provided in the Hall IC 45 from the space portion 41a so as to be connected, respectively, to the base portions 32 of a plurality of the lead frames 30, and mounts the condensers 50 between a pair of the leads 45a present in the space portion 41a.

According to such a configuration, the Hall IC 45 and the condenser 50 are accommodated inside the space portion 41a, and thus, it is possible to collectively provide these components to one place. Therefore, it is possible to achieve downsize of the structure. In addition, the condenser 50 is directly mounted to the lead 45a of the Hall IC 45, and is accommodated in the same space, and thus, it is possible to arrange the Hall IC 45 and the condenser 50 at a close distance. In this manner, it is possible to suppress a problem in that an efficiency of noise elimination deteriorates. In addition, in a case where the condenser 50 is mounted to the lead frame 30, the condenser 50 directly receives influence caused by expansion and contraction of the lead frame 30. However, in a case where the condenser 50 is directly mounted to the lead 45a, there is an effect that the influence caused by the expansion and contraction of the lead frame 30 is small because such influence is absorbed and mitigated by bending of the lead 45a.

In addition, in the present embodiment, the space portion 41a is molded by the resin material 60 filled in the space.

According to such a configuration, it is possible to protect the Hall IC 45 and the condenser 50 by filling the space portion 41a with the resin material 60. In addition, as described above, the Hall IC 45 and the condenser 50 are collectively provided to one place, and thus, it is possible to efficiently perform an application operation of the resin material 60, and further, to suppress the amount of the application.

In addition, in the manufacturing process of the liquid level sensor 10 according to the present embodiment, as illustrated in the third step, the Hall IC 45 is accommodated in the space portion 41a of the inner member 41, and the plurality of leads 45a are extended from the space portion 41a, and connected, respectively, to the plurality of lead frames 30. Further, in the fourth step, the condenser 50 is mounted between the pair of leads 45a.

For example, the Hall IC 45 can be accommodated in the space portion 41a with the condenser 50 being mounted to the lead 45a of the Hall IC 45, and the plurality of leads 45a are connected, respectively, to the plurality of lead frames 30. Regardless to say, such a technique may be applied in the present embodiment, but there is a possibility that stress acts on a connection portion due to deformation of the lead 45a or the like when the lead 45a is connected with the lead frame 30 in the state of being equipped with the condenser 50. With respect to such a point, it is possible to reduce such a possibility by accommodating the Hall IC 45 in the space portion 41a, and thereafter, equipping the Hall IC 45 with the condenser 50 as described above.

As described above, the description has been made regarding the liquid level sensor according to the present embodiment, but the present invention is not limited to the embodiment, and various modifications are possible in the range of the invention. In addition, not only the liquid level sensor but also the method of manufacturing the liquid level sensor serves a function as a part of the present invention.

For example, although the description has been made regarding the liquid level sensor for a vehicle, which detects the fuel level in the above-described embodiment, the present invention is not limited to the use for the vehicle, and may be used for other applications. In addition, the description has been made regarding the liquid level sensor of a non-contact type in the above-described embodiment, but the present invention is not limited to the non-contact type, and may be other types such as a contact type. In addition, the condenser has been exemplified as the electronic component used together with the Hall IC which is the detection element, but another electronic component may be used.

In addition, it is possible to widely apply the present invention to a sensor other than the liquid level sensor. That is, the sensor according to the present invention is not limited to the sensor having the liquid level as the detection object, but is any sensor as long as including a configuration in which a detection element outputs a physical quantity relating to a detection object, or an electrical signal depending on the amount of a variation in the detection object.

According to the present invention, by accommodating a detection element and an electronic component in a space portion, it is possible to collectively provide these parts to one place, and thus, it is possible to achieve downsize of a structure. In addition, it is possible to arrange the electronic component and the detection element at a close distance by directly mounting the electronic component to a lead of the detection element, and accommodating these parts in the same space. In this manner, it is possible to suppress a problem in that an effect of noise elimination deteriorates.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sensor comprising:
a detection element configured to output an electrical signal depending on a physical quantity relating to a detection object or an amount of a variation in the detection object;
an electronic component configured to be used together with the detection element;
a plurality of lead frames configured to include a terminal portion to which a conductive wire is connected, and a base portion to which a lead of the detection element is connected; and
an inner member configured to hold the plurality of lead frames, wherein
the inner member includes a space portion recessed in a concave shape, and accommodates the detection element in the space portion, and
the detection element extends a plurality of the leads included in the detection element itself from the space portion so as to be connected, respectively, to the base portion of the plurality of lead frames, and mounts the electronic component between a pair of the leads present in the space portion.

2. The sensor according to claim 1, wherein
the space portion is molded by a resin material filled in a space.

3. The sensor according to claim 2, further comprising:
a sensor housing configured to be obtained by insert-molding the plurality of lead frames and the inner member, as insert components, so as to expose a terminal portion of each of the lead frames and accommodate remaining portions of each of the lead frames.

4. A method of manufacturing a sensor that accommodates a detection element, which outputs an electrical signal depending on a physical quantity relating to a detection object or an amount of a variation in the detection object, inside a sensor housing, the method comprising:
a step of preparing a plurality of lead frames including a terminal portion of which a distal end is connected with a conductive wire;
a step of insert-molding the plurality of lead frames as an insert component, and forming an inner member that holds a base end side of the plurality of lead frames and includes a space portion recessed in a concave shape;
a step of accommodating the detection element in the space portion of the inner member, and extending a plurality of leads included in the detection element from the space portion so as to be connected, respectively, to the plurality of lead frames;
a step of mounting an electronic component, which is used together with the detection element, between a pair of the leads present in the space portion;
a step of filling the space portion with a resin material, and molding an inside of a space of the space portion; and
a step of forming the sensor housing so as to expose the terminal portion of each of the lead frames and accommodate remaining portions of each of the lead frames.
